(19) United States
(12) Patent Application Publication
(10) Pub. No.: US 2009/0113235 A1
(43) Pub. Date: Apr. 30, 2009

(54) RAID WITH REDUNDANT PARITY

(76) Inventor: ROBERT D. SELINGER, San Jose, CA (US)

Correspondence Address: PATTERSON & SHERIDAN, L.L.P., 3040 POST OAK BLVD., SUITE 1500, HOUSTON, TX, 77056, US

(21) Appl. No.: 11/929,014

(22) Filed: Oct. 30, 2007

(51) Int. Cl. G06F 11/10; G06F 12/00

(52) U.S. Cl. 714/6; 711/114; 711/E12.001; 714/E11.034

(57) ABSTRACT

Methods and apparatus of the present invention include storing redundant parity information in storage devices that are configured in a RAID array. Conventional hard disk drives are configured to store data in RAID 3 or RAID 4 data layouts. A storage controller is configured to generate the parity information for the data written to the hard disk drives. One or more of the devices storing the parity information may be a flash storage device.

### BACKGROUND OF THE INVENTION

1. Field of the Invention

Embodiments of the present invention generally relate to adding additional redundancy in some Redundant Array of Independent Disks/Drives (RAID) configurations and configuring flash memory devices in a RAID to store parity information.

2. Description of the Related Art

Conventional RAID systems use hard disk drives to store data and parity information. In RAID systems that store parity information on a separate parity hard disk drive, the access time needed to update the parity information may reduce the performance of the RAID array. One solution to reduce the access time for the parity hard disk drive includes a cache in front of the parity hard disk drive. This solution is a proprietary product that is available from a single vendor and has a high cost. Additionally, in order to prevent the loss of cache data during a power loss, an uninterruptable power supply must be used in the RAID system.

This presents the need for an improved method and system for storing parity information in a RAID array.

### SUMMARY OF THE INVENTION

The reliability of RAID arrays configured to support RAID 3, RAID 4, and RAID 7 is improved by including redundant parity information. The parity information and/or redundant parity information may be stored using a flash storage device instead of a conventional hard disk drive. The flash storage device is available from multiple vendors and does not require an uninterruptable power supply. Dual flash storage devices are configured to store parity information in a RAID array to reduce the time needed to regenerate the parity information in the event of a dual failure compared with using conventional hard disk drives to store the parity information. A RAID 3 or RAID 4 data layout is used for data storage with additional redundant storage device(s) to provide dual parity.

Various embodiments of the invention provide a method for configuring flash storage devices in a RAID system that includes configuring a set of hard disk drive storage devices to store data in stripes in the RAID system, configuring a flash storage device in the RAID system to store parity information for the data, computing the parity information for a stripe of data as the stripe of data is written to the set of hard disk drive storage devices, and storing the parity information for the stripe of data in the flash storage device.

Various embodiments of the invention provide a method for configuring storage devices in a RAID system. The method includes configuring a set of hard disk drive storage devices to store data in stripes in the RAID system, configuring a flash storage device in the RAID system to store parity information for the data, computing the parity information for a stripe of data as the stripe of data is written to the set of hard disk drive storage devices, and storing the parity information for the stripe of data in the flash storage device.

Various embodiments of the invention provide a system for configuring storage devices in redundant array of independent disks/drives (RAID) that includes a RAID array of flash storage devices and a storage controller. The RAID array of storage devices includes a set of hard disk drive storage devices configured to store data in stripes, a first storage device configured to store parity information for the data, and a second storage device configured to store redundant parity information for the data. The storage controller is coupled to the first storage device, the second storage device, and each one of the hard disk storage devices in the set of hard disk storage devices. The storage controller is configured to store the data in the stripes in the set of hard disk drive storage devices, compute the parity information for each one of the stripes that is written, compute redundant parity information for each one of the stripes that is written, store the parity information in the first storage device, and store the redundant parity information in the second storage device.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an example system including a RAID array and a flash device for storing parity information.

FIGS. 2A and 2B illustrate example striping configurations for the RAID array devices.

FIG. 3A is an example RAID configuration using data striping and dual parity, in accordance with an embodiment of the method of the invention.

FIG. 3B is a flow chart of operations for storing data and parity information, in accordance with an embodiment of the method of the invention.

FIG. 4A is an example RAID configuration using a flash device, in accordance with an embodiment of the method of the invention.

FIG. 4B is a flow chart of operations for storing data and parity information, in accordance with an embodiment of the method of the invention.

FIG. 5 is another example RAID configuration using data striping and dual parity, in accordance with an embodiment of the method of the invention.

### DETAILED DESCRIPTION

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and, unless explicitly present, are not considered elements or limitations of the appended claims.

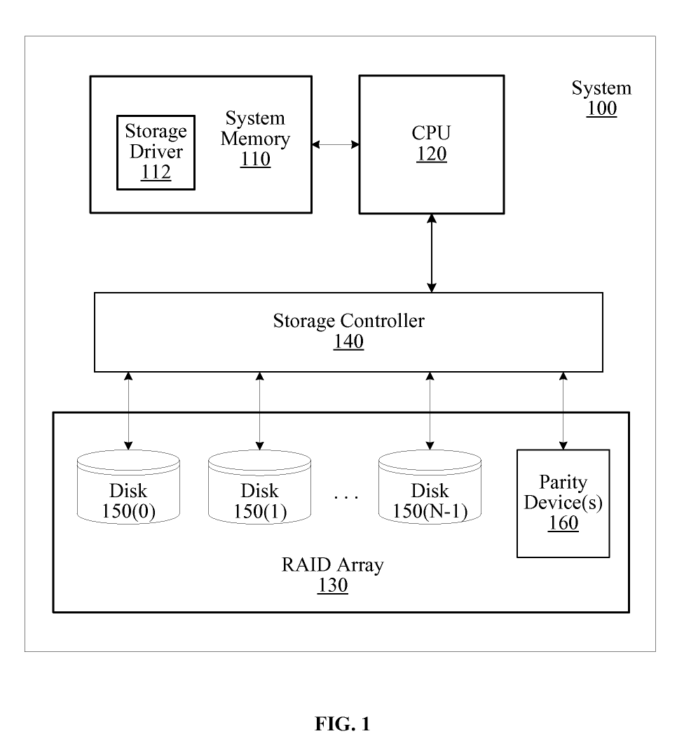

FIG. 1 is a block diagram of an exemplary embodiment of a respective system 100 in accordance with one or more aspects of the present invention. System 100 includes a central processing unit, CPU 120, a system memory 110, a storage controller 140, and a RAID array 130. System 100 may be a desktop computer, server, storage subsystem, Network Attached Storage (NAS), laptop computer, palm-sized computer, tablet computer, game console, portable wireless terminal such as a personal digital assistant (PDA) or cellular telephone, computer based simulator, or the like. CPU 120 may include a system memory controller to interface directly to system memory 110. In alternate embodiments of the present invention, CPU 120 may communicate with system memory 110 through a system interface, e.g., I/O (input/output) interface or a bridge device.

Storage controller 140 is coupled to CPU 120 via a high bandwidth interface. In some embodiments of the present invention the high bandwidth interface is a standard conventional interface such as a peripheral component interface (PCI). Storage controller 140 may be configured to function as a RAID 7 controller, a RAID 3 controller, a RAID 4 controller, a RAID 6 controller, or the like. A conventional RAID 3 configuration of RAID array 130 includes a single dedicated parity drive and byte level striping. A conventional RAID 4 configuration of RAID array 130 includes a single dedicated parity drive and block (or chunk) level striping. A conventional RAID 6 configuration of RAID array 130 includes a distributed parity drive and block (or chunk) level striping. A conventional RAID 7 configuration of RAID 7 is a proprietary solution that uses a cache in front of a single dedicated parity drive. In other embodiments of the present invention, the I/O interface, bridge device, or storage controller 140 may include additional ports such as universal serial bus (USB), accelerated graphics port (AGP), and the like.

RAID array 130 includes one or more storage devices, specifically N hard disk drive 150(0) and drives 150(1) though 150(N−1) that are configured to store data and are each directly coupled to storage controller 140 to provide a high bandwidth interface for reading and writing the data. One or more additional memory devices, parity device(s) 160 is configured to store parity information and is also coupled to storage controller 140 to provide a high bandwidth interface for reading and writing parity information. Parity device(s) 160 may be a single flash storage device configured to store parity information or two hard disk drives or flash storage devices configured to store dual (redundant) parity information.

Each storage device within RAID array 130, e.g., disks 150(0), 150(1), 150(N−1), and parity device(s) 160 may be replaced or removed, so at any particular time, system 100 may include fewer or more storage devices. Storage controller 140 facilitates data transfers between CPU 120 and RAID array 130, including transfers for performing parity functions. Alternatively, parity computations are performed by storage controller 140. In some embodiments of the present invention, parity device(s) 160 are packaged in a multi-chip-module with or without storage controller 140. Disks 150(0) through 150(N−1) are collectively referred to as disks 150.

In some embodiments of the present invention, storage controller 140 performs block striping and/or data mirroring based on instructions received from storage driver 112. Each drive 150 and parity device(s) 160 coupled to storage controller 140 includes drive electronics that control storing and reading of data within the disk 150 or parity device(s) 160. Data is passed between storage controller 140 and each disk 150 or parity device(s) 160 via a bi-directional bus. Each disk 150 or parity device(s) 160 includes circuitry that controls storing and reading of data within the individual storage device and is capable of mapping out failed portions of the storage circuitry based on bad sector information.

System memory 110 stores programs and data used by CPU 120, including storage driver 112. Storage driver 212 communicates between the operating system (OS) and storage controller 140 to perform RAID management functions such as detection and reporting of storage device failures, maintaining state data, e.g., bad sectors, address translation information, and the like, for each storage device within RAID array 130, and transferring data between system memory 110 and RAID array 130.

An advantage of using a flash storage device within RAID array 130 is that the time needed to write the parity information is reduced. Using dual parity with a RAID 3 or RAID 4 data layout is advantageous since dual parity provides greater fault tolerance. Furthermore, in the event of parity device failure, the parity information can be regenerated using a single read pass of the data. NAND flash devices, multi level cell (MLC) flash devices, or single level cell (SLC) flash devices may be used for parity device(s) 160. Storage controller 140 may manage wear leveling on parity device(s) 160 at the device, page, block, or array level when flash storage device(s) are used to store the parity information. Additionally, storage controller 140 may map out failing flash devices or portions of those devices without suffering a loss of data and/or capacity.

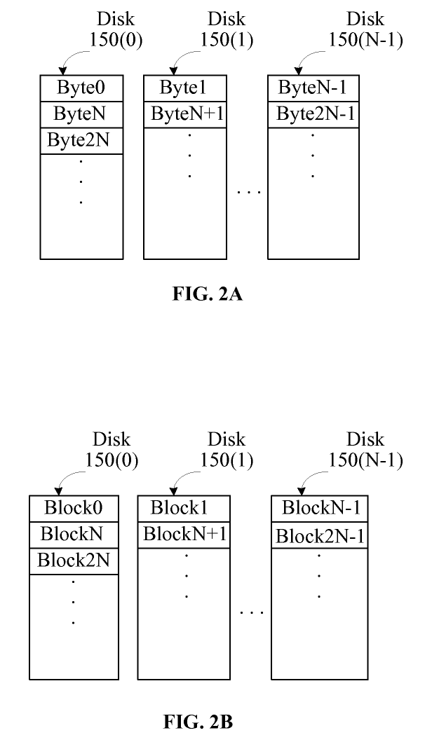

FIG. 2A illustrates an example striping configuration for disks 150. Disks 150 are organized in stripes, where a stripe includes a portion of each disk in order to distribute the data across the disks 150. As shown in FIG. 2A, the data is striped with successive bytes of data being stored in different disks. For example, a first stripe includes Byte0, and Byte1 through ByteN−1. Similarly, a second strip includes ByteN and ByteN+1 through Byte2N−1. When the data is striped in bytes the effective sector size is N*S, where N is the number of disks and S is the sector size of the disks.

FIG. 2B illustrates another example striping configuration for disks 150(0) through 150(N−1). As shown in FIG. 2B, successive blocks of data are stored on different disks. For example, a first stripe includes Block0, and Block1 through BlockN−1. Similarly, a second strip includes BlockN and BlockN+1 through Block2N−1. When the data is striped in blocks the effective block size is S, the sector size of the disks. The striping configuration shown in FIGS. 2A and 2B may be used to support RAID 3, RAID 4, and RAID 6 data layouts.

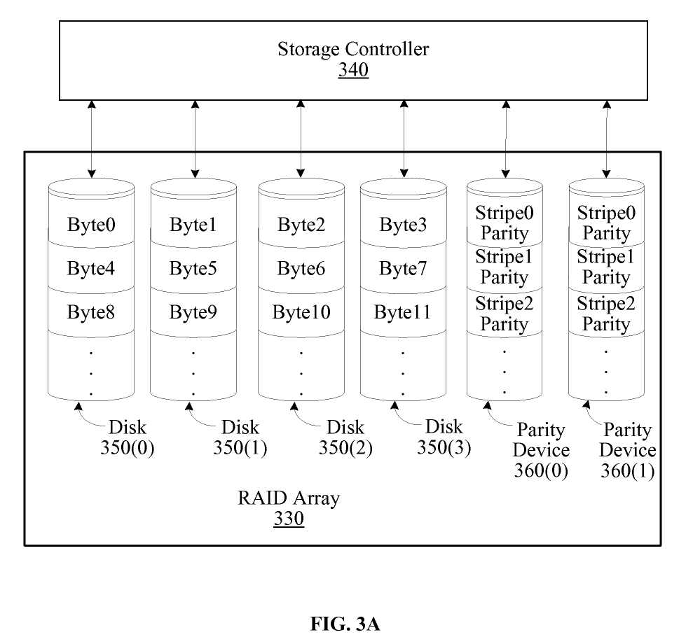

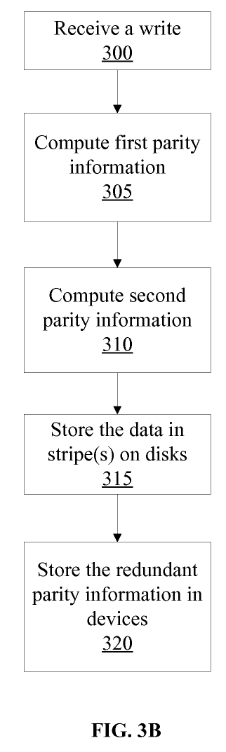

FIG. 3A is an example RAID configuration using data striping and dual parity, in accordance with an embodiment of the method of the invention. Dual parity enables the RAID system to tolerate two failures advantageously increasing the fault tolerance of the system. The configuration shown in FIG. 3A may be used to support RAID 3, RAID 4, or RAID 6 in system 100 of FIG. 1 with parity devices 360(0) and 360(1) corresponding to parity device(s) 160. Parity devices 360(0) and 360(1) each store parity for each byte stripe of data stored in a disks 350(0), 350(1), 350(2), and 350(3) within RAID array 330. Disks 350 and storage controller 340 correspond to disks 150 and storage controller 140 shown in FIG. 1, respectively.

Storage controller 340 computes an even or odd parity for each stripe as data is written to a first portion of disks 350, and stores the even parity in parity device 360(0) and the odd parity in parity device 360(1). When even parity is used a parity bit is set to 1 when the number of ones in a given set of bits is odd, otherwise the parity bit is set to 0. When odd parity is used an odd parity bit is set to 1 when the number of ones in a given set of bits is even, otherwise, the parity bit is set to 0. Storage controller 350 determines if a parity test fails on a data read operation, and regenerates the missing data using the remaining data within the stripe and the parity for that stripe stored in either parity device 360(0) or 360(1). Similarly, if both parity devices 360 fail, storage controller 350 can regenerate the parity information and the redundant parity information.

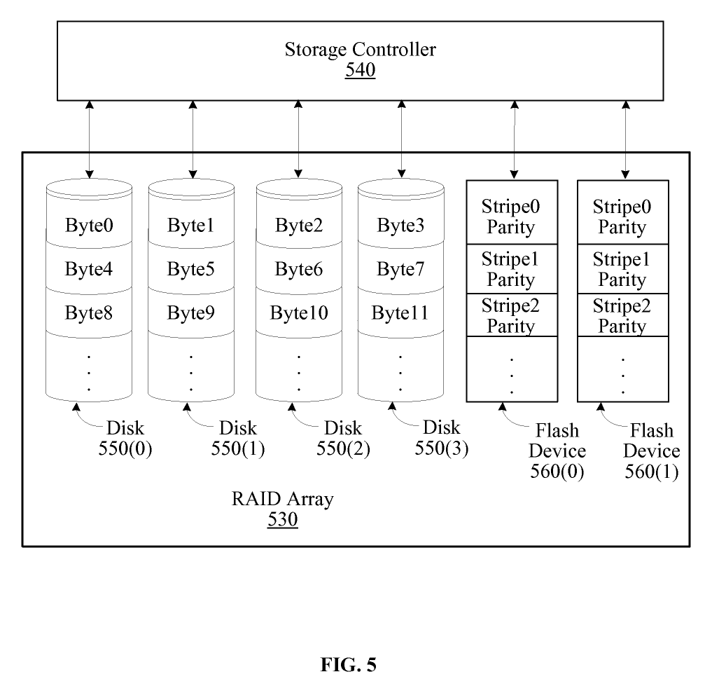

In other embodiments of the present invention, other redundant parity computations are performed to compute the parity information for parity devices 360(0) and 360(1). Additionally, parity devices 360 may be conventional hard disk drives or flash storage devices, as described in conjunction with FIG. 5. Although the data layout shown is consistant with striping for RAID 3 or RAID 4, other data layouts may be used in other configurations of the present invention.

FIG. 3B is a flow chart of operations for storing data and parity information, in accordance with an embodiment of the method of the invention. In step 300 storage controller 340 receives a write request to write data to disks 350. In step 305 storage controller 340 computes the first parity information, e.g., even parity or odd parity, for the data in the write request. In step 310 storage controller 340 computes the second parity information, e.g., odd parity or even parity, for the data in the write request. The second parity information is redundant and either the first parity information or the second parity information may be used to regenerate the data stored in disks 350 when a failure occurs. In step 315 storage controller 340 stores the data in stripes on disks 350. In step 320 storage controller 340 stores the redundant parity information for the stripes in parity devices 360.

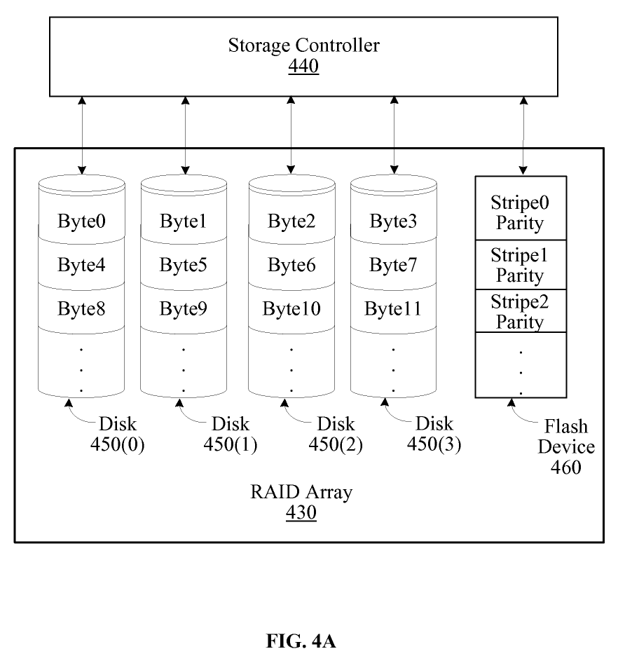

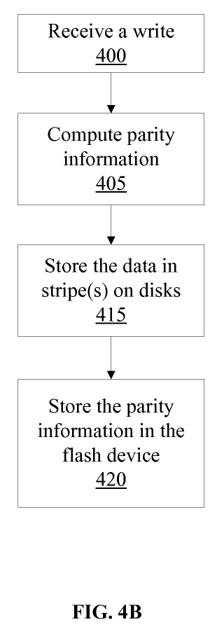

FIG. 4A is an example RAID configuration using a flash device 160 to store parity information, in accordance with an embodiment of the method of the invention. The configuration shown in FIG. 4A may be used to support RAID 3 or RAID 4 in system 100 of FIG. 1 with flash device 460 corresponding to parity device(s) 160. Flash device 460 stores XOR (exclusive OR) parity for each byte stripe of data stored in disks 450(0), 450(1), 450(2), and 450(3). Disks 450 and storage controller 440 correspond to disks 150 and storage controller 140 shown in FIG. 1, respectively. Storage controller 440 computes an XOR parity for four bytes at a time as data is written to a first portion of disks 450, and stores the XOR parity in flash device 460, as described in conjunction with FIG. 4B. Storage controller 440 determines if a CRC fails on a data read operation, and regenerates the missing data using the remaining data within the stripe and the parity for that stripe. Storage controller 440 determines if there is a failure of flash device 460 and if needed the parity information is regenerated and stored in flash device 460. Although four disks 450 are shown in RAID array 430 of FIG. 4A, in other embodiments of the present invention, fewer or additional disks 450 may be used.

FIG. 4B is a flow chart of operations for storing data and parity information, in accordance with an embodiment of the method of the invention. In step 400 storage controller 440 receives a write request to write data to disks 450. In step 405 storage controller 440 computes the parity information for the data in the write request. In step 415 storage controller 440 stores the data in stripes on disks 450. In step 420 storage controller 440 stores the parity information for the stripes in flash device 460.

FIG. 5 is another example RAID configuration using disks 550(0), 550(1), 550(2), 550(3), and flash devices 560(0) and 560(1) in RAID array 530, in accordance with an embodiment of the method of the invention. The configuration shown in FIG. 5 may be used to support RAID 3, RAID 4, or RAID 6 with data striping. Flash devices 560(0) and 560(1) correspond to parity device(s) 160 of FIG. 1 and are configured to store parity information for each byte stripe of data stored in disks 550. Specifically, flash devices 560(0) and 560(1) are configured to store redundant or dual parity information. For example, flash device 560(0) may store even parity for each data stripe stored in disks 550 and flash device 560(1) may store odd parity for each data stripe stored in disks 550. In some embodiments of the present invention, one of the two flash devices 560(0) and 560(1) is replaced with a conventional hard disk drive storage device.

Storage controller 540 computes an odd and even parity as data is written to disks 550 and stores the parity information and redundant parity information in flash device 560(0) and 560(1), respectively, as described in conjunction with FIG. 4B. Storage controller 550 determines if a parity test fails on a data read operation, and regenerates the missing data using the remaining data within the stripe and the parity for that stripe. Similarly, if both flash devices 560 fail, storage controller 550 can regenerate the parity information. When flash devices 560 are used instead of disk drives for storing the parity information, the parity information can be generated in a single read pass of disks 550.

As previously described, NAND flash devices, multi level cell (MLC) flash devices, or single level cell (SLC) flash devices may be used for flash device 560(0) and 560(1). Storage controller 540 may manage wear leveling on flash device 560(0) and 560(1) at the device, page, block, or array level. Additionally, storage controller 540 may map out failing flash devices or portions of those devices without suffering a loss of data and/or capacity.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

While the foregoing is directed to embodiments of the present invention, other and further embodiments of the invention may be devised without departing from the basic scope thereof, and the scope thereof is determined by the claims that follow. The foregoing description and drawings are, accordingly, to be regarded in an illustrative rather than a restrictive sense. The listing of steps in method claims do not imply performing the steps in any particular order, unless explicitly stated in the claim.

The invention claimed is:

1. A method for configuring storage devices in redundant array of independent disks/drives (RAID), comprising:
configuring a set of hard disk drive storage devices to store data in stripes in a RAID system;
configuring a flash storage device in the RAID system to store parity information for the data;
computing the parity information for a stripe of data as the stripe of data is written to the set of hard disk drive storage devices; and
storing the parity information for the stripe of data in the flash storage device.

2. The method of claim 1, further comprising:
configuring an additional flash storage device in the RAID system to store redundant parity information for the data;
computing the redundant parity information for the stripe of data as the stripe of data is written to the set of hard disk drive storage devices; and
storing the redundant parity information for the stripe of data in the additional flash storage device.

3. The method of claim 2, wherein the parity information is even parity and the redundant parity information is odd parity or the parity information is odd parity and the redundant parity information is even parity.

4. The method of claim 1, further comprising:
reading portions of data from the set of hard disk drive storage devices;
determining a data read failure has occurred for a first portion of the portions of data in a stripe; and
regenerating the first portion using the other portions of the data in the stripe and the parity information for the stripe.

5. The method of claim 1, further comprising:
determining a parity failure has occurred for the parity information stored in the flash storage device;
reading the data from the set of hard disk drive storage devices;
regenerating the parity information for the data; and
storing the parity information in the flash storage device.

6. The method of claim 1, wherein the parity information is even parity or odd parity.

7. The method of claim 1, wherein the stripe of data includes successive bytes of the data.

8. The method of claim 1, wherein the stripe of data includes successive pages of the data.

9. A method for configuring storage devices in redundant array of independent disks/drives (RAID), comprising:
configuring a set of hard disk drive storage devices to store data in stripes in a RAID system;
configuring a first storage device in the RAID system to store parity information for the data;
configuring a second storage device in the RAID system to store redundant parity information for the data;
computing the parity information for a stripe of data as the stripe of data is written to the set of hard disk drive storage devices;
computing the redundant parity information for a stripe of data as the stripe of data is written to the set of hard disk drive storage devices;
storing the parity information for the stripe of data in the first storage device; and
storing the redundant parity information for the stripe of data in the second storage device.

10. The method of claim 9, further comprising:
determining a parity failure has occurred for the parity information stored in the first storage device and the redundant parity information stored in the second storage device;
reading the data from the set of hard disk drive storage devices;
regenerating the parity information for the data;
regenerating the redundant parity information for the data;
storing the parity information in the first storage device; and
storing the redundant parity information in the second storage device.

11. The method of claim 9, wherein the first storage device is a flash storage device.

12. The method of claim 9, wherein the second storage device is a flash storage device.

13. The method of claim 9, wherein the first parity information is even parity for each stripe of data that is stored in the set of hard disk drive storage devices and the redundant parity information is odd parity for each stripe of data that is stored in the set of hard disk drive storage devices.

14. A system for configuring storage devices in redundant array of independent disks/drives (RAID), comprising:
a RAID array of storage devices including:
a set of hard disk drive storage devices configured to store data in stripes;
a first storage device configured to store parity information for the data; and
a second storage device configured to store redundant parity information for the data; and
a storage controller coupled to the first storage device, the second storage device, and each one of the hard disk storage devices in the set of hard disk storage devices and configured to:
store the data in the stripes in the set of hard disk drive storage devices;
compute the parity information for each one of the stripes that is written;
compute redundant parity information for each one of the stripes that is written;
store the parity information in the first storage device; and
store the redundant parity information in the second storage device.

15. The system of claim 14, wherein the first storage device is a flash storage device.

16. The system of claim 14, wherein the parity information is even parity and the redundant parity information is odd parity or the parity information is odd parity and the redundant parity information is even parity.

17. The system of claim 14, wherein the storage controller is further configured to:
determine a parity failure has occurred for the parity information stored in the first storage device;
read the data from the set of hard disk drive storage devices;
regenerate the parity information for the data; and
store the parity information in the first storage device.

18. The system of claim 14, wherein the storage controller is further configured to configured to perform wear leveling for the first storage device.

19. The system of claim 14, wherein the stripes of data include successive bytes of the data.

20. The system of claim 14, wherein the stripes of data include successive blocks of the data.
